(19) United States
(12) Patent Application Publication
(10) Pub. No.: US 2006/0158563 A1
(43) Pub. Date: Jul. 20, 2006

(54) Convergence compensation apparatus and convergence method for a projection television

(75) Inventors: Jae-seung Shim, Hwaseong-si (KR); Sung-gi Kim, Suwon-si (KR); Young-jai Bai, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/333,347

(22) Filed: Jan. 18, 2006

(30) Foreign Application Priority Data
Jan. 20, 2005 (KR) 2005-5483

(51) Int. Cl. H04N 5/21; H04N 5/213; H04N 5/217

(52) U.S. Cl. 348/614

(57) ABSTRACT

A convergence compensation apparatus includes a memory for storing a manual convergence compensation data which is preset by a user, and a convergence control unit for applying the manual convergence compensation data and an automatic convergence compensation data generated by the automatic color coincidence task, and for allowing a convergence distortion of the projection television to be compensated.

This application claims benefit under 35 U.S.C. § 119 from Korean Patent Application No. 2005-5483, filed on Oct. 23, 2003, the entire content of which is incorporated herein by reference.

### BACKGROUND OF THE INVENTION

1. Field of the Invention

The present invention relates to a projection television and in particular, relates to a convergence compensation apparatus and method which are applied to the projection television.

2. Description of the Related Art

A projection television using a CRT or an LCD display employs a method for representing an image signal as a visually recognizable image by scanning a color corresponding to each tone of color on a screen. At this time, a precise position of a cathode ray to be scanned is controlled by applying a magnetic field to a deflection of a cathode ray, and adjusting. Accordingly, a deflection degree of a cathode ray is affected directly by the magnetic field.

Generally, when producing a projection television on a production line, the deflection degree of a cathode ray is adjusted so that a cathode ray can be scanned precisely on a desired position of the screen. Hereinafter, a data for compensating a convergence distortion of a projection television with the deflection degree adjusted on the production line is known as an initial compensation data. However, the intensity of an earth magnetic field at a place where a projection television is actually arranged is different from that of an earth magnetic field at a place where the production line is located. Therefore, a changed earth magnetic field influences upon a precise image forming of the projection television. In other word, such difference of the earth magnetic fields generates a distortion affecting the deflection degree of a cathode ray so that a precise image can not be formed on a screen. Thus, an apparatus for compensating an influence of the earth magnetic field is embedded in the projection television in order to compensate an influence of the earth magnetic field which varies according to different regions. This apparatus is called as a compensation apparatus.

Further, a projection television which has been marketed recently so as to supply a good-quality image forming may perform a process for automatically compensating a convergence distortion of a projection television (that is, an automatic color coincidence task), or a manual color coincidence task for compensating a convergence distortion of a projection television by manipulation of a user. As described above, the reason why a manual coincidence task as well as an automatic color coincidence task is required is that the most superior image can be formed through a final color coincidence task according to users' tastes. Hereafter, a data generated for compensating a convergence distortion by driving automatically the convergence compensation apparatus is an automatic convergence compensation data. A data generated for compensating a convergence distortion by driving the convergence compensation apparatus by manipulation of a user is a manual convergence compensation data.

However, in the prior art, an initial compensation data, and an automatic convergence compensation data were used, and a convergence compensation task is performed, and then a user manually sets a convergence to an optimal state. In case that an automatic color coincidence task is performed again, there was a problem that a user had to generate and apply a manual convergence compensation data by performing a manual color coincidence task once again. That is, the user had to repeat a troublesome manual color coincidence task once again whenever an automatic color coincidence task is performed.

### SUMMARY OF THE INVENTION

Illustrative, non-limiting exemplary embodiments of the present invention overcome the above disadvantages, and other disadvantages not described above.

An apparatus consistent with the present invention provides a convergence compensation apparatus and a convergence method which prevents repetition of a manual color coincidence task by manipulation of a user by storing a manual convergence compensation data generated through an initial manual color coincidence task, and an automatic convergence compensation data generated through an initial automatic color coincidence task, into a predetermined memory, respectively, and by applying them to a convergence compensation task.

The convergence compensation method according to the present invention may comprise a step for compensating a convergence distortion of the projection television by applying manual convergence compensation data which are preset and stored by a user.

The convergence compensation method may further comprise a step for generating the manual convergence compensation data by performing a manual color coincidence task for compensating a convergence distortion of the projection television by manipulation of a user; and a step for storing the generated manual convergence compensation data.

The convergence compensation method may further comprise a step for compensating a convergence distortion of the projection television by applying an automatic convergence compensation data generated and stored by an automatic color coincidence task for automatically compensating a convergence distortion of the projection television.

The convergence compensation method may further comprise a step for measuring a convergence distortion state of the projection television; a step for generating the automatic convergence compensation data by performing the automatic color coincidence task for automatically compensating a convergence distortion of the projection television according to the measured convergence distortion state; and a step for storing the generated automatic convergence compensation data.

Still further, a convergence compensation method according to the present invention is a convergence compensation method for compensating a convergence distortion of a projection television, and the method may comprise a step for compensating a convergence distortion of the projection television by applying an automatic convergence compensation data generated and already stored by performing an automatic color coincidence task for automatically compensating a convergence distortion of the projection television, when performing another automatic color coincidence task which is different from the automatic color coincidence task.

The convergence compensation method may further comprise a step for measuring a distortion state of a convergence of the projection television; a step for generating the automatic convergence compensation data by performing the automatic color coincidence task according to the measured convergence distortion state; and a step for storing the generated automatic convergence compensation data.

The convergence compensation method may further comprise a step for performing an automatic color coincidence task according to an execution command for the automatic color coincidence task, when the execution command for the automatic color coincidence task is inputted; and a step for updating the automatic convergence compensation data with an automatic convergence compensation data generated by the automatic color coincidence task.

Still further, a convergence compensation apparatus according to the present invention, for performing an automatic color coincidence task for automatically compensating a convergence distortion of a projection television, may comprise a memory for storing a manual convergence compensation data which is preset by a user; and a convergence control unit for applying the manual convergence compensation data and an automatic convergence compensation data generated by the automatic color coincidence task, and for allowing a convergence distortion of the projection television to be compensated.

In the memory of the convergence compensation apparatus, the memory further stores the preset automatic convergence compensation data; and the convergence control unit reads the automatic convergence compensation data stored when performing an automatic color coincidence task, and applies the data to the automatic color coincidence task.

Yet further, a convergence compensation apparatus according to the present invention is a convergence compensation apparatus performing an automatic color coincidence task for automatically compensating a convergence distortion of a projection television, and the apparatus may comprise a memory for storing an automatic convergence compensation data generated by an automatic color coincidence task; and a convergence control unit for allowing the stored automatic convergence compensation data to be applied to another automatic color coincidence task, when performing the other automatic color coincidence task which is different from the automatic color coincidence task.

The convergence compensation apparatus may further comprise an input unit to which an execution command for the automatic color coincidence task is inputted; and wherein the convergence control unit updates the automatic convergence compensation data stored in the memory with an automatic convergence compensation data generated by an automatic color coincidence task according to the execution command for the automatic color coincidence task.

Therefore, unlike the prior art, a manual color coincidence task required after automatic color coincidence task is not necessary in the present invention, thereby removing a troublesome operation.

### BRIEF DESCRIPTION OF THE DRAWINGS

The above aspects and/or other aspects of the present invention will become apparent and more readily appreciated from the following description of exemplary embodiments of the present invention with reference to the accompanying drawings, in which:

FIG. 1 is a block diagram for showing schematically a projection television provided with a convergence compensation apparatus according to the present invention;

FIG. 2 is a flow chart for explaining initial color coincidence execution procedures according to the present invention;

FIG. 3 is a flow chart for explaining color coincidence execution procedures after the initial color coincidence execution procedures according to the present invention; and

FIG. 4 is a flow chart for explaining other color coincidence execution procedures after the initial color coincidence execution procedures according to the present invention.

### DETAILED DESCRIPTION OF THE EXEMPLARY EMBODIMENTS

Exemplary embodiments of the present invention will be described in greater detail with reference to the accompanying drawings. Also, well-known functions or constructions are not described in detail since they would obscure the invention in unnecessary detail.

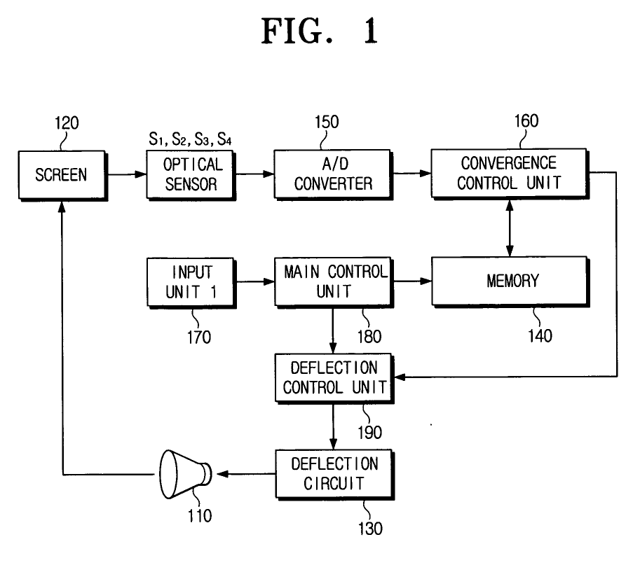

FIG. 1 is a block diagram showing schematically a projection television provided with a convergence compensation apparatus according to the present invention.

A projection television is composed of a CRT 110 forming a picture image by reproducing an image signal, a screen 120 displaying the picture image formed by the CRT 110, and a deflection circuit 130 controlling a picture image forming operation by adjusting deflection of the cathode rays. Here, the projection television has three CRTs 110 displaying the picture image separately, according to each color tone color of R, G, and B. The picture image formed by each CRT 110 is reflected by a mirror (not shown) and the reflected image is displayed on the screen 120. The projection television may employ an LCD apparatus except the CRT 110 as an image display device.

Further, the projection television comprises a memory 140 storing a compensation data against influence of an earth magnetic field, that is, an initial compensation data, an automatic convergence compensation data and a manual convergence compensation data, an optical sensor (S₁, S₂, S₃, S₄) sensing the brightness of a reference pattern formed on the screen 120, an A/D converter 150 converting the output voltage of the optical sensor (S₁, S₂, S₃, S₄) into a digital data, a convergence control unit 160 generating the automatic convergence compensation data and the manual convergence compensation data, and compensating distortions of the earth magnetic field by using the generated compensation data, an input unit 170 through which various commands of a user are inputted, a main control unit 180 controlling the projection television as a whole, and a deflection control unit 190 controlling the operations of a deflection circuit 130 according to the controls of the main control unit 180 and the convergence control unit 160.

The initial compensation data, the automatic convergence compensation data and the manual convergence compensation data are stored into the memory 140 according to the present invention. As described above. The initial compensation data means a convergence compensation data which is created for compensating distortions of the earth magnetic field on the production line. Further, the automatic convergence compensation data means a convergence compensation data which is created through an automatic color coincidence task, and is applied. Further, the manual convergence compensation data means a convergence compensation data which is created by a color coincidence task performed by manipulation through the input unit 170 of a user, and is applied. Further, the memory 170 stores a reference pattern for a convergence compensation.

The optical sensor (S₁, S₂, S₃, S₄) outputs a voltage corresponding to brightness by sensing the brightness of the reference pattern which is irradiated on the screen 120. The voltage outputted from the optical sensor (S₁, S₂, S₃, S₄) is converted into a digital data by the A/D converter 150.

The convergence control unit 160 generates a convergence compensation data based upon the data outputted from the A/D converter 150. The convergence compensation data is classified into an automatic convergence compensation data and a manual convergence compensation data according to the operators of the compensation task. Such a convergence compensation data can be generated based upon a compensation vector created by the digital data outputted from the A/D converter 150, and the reference pattern which is already set and stored into the memory 140.

The convergence control unit 160 compensates the influence of the earth magnetic field which the deflection circuit 130 applies on the CRT 110 by controlling the deflection control unit 190 according to each convergence compensation data.

The convergence control unit 160 according to the present invention reads the initial data stored into the memory 140 when executing the color coincidence task, and compensates the distortions of a convergence of the picture image by controlling the deflection control unit 190 according to the read initial data.

Below, a color coincidence task after the initial color coincidence task, and the time when the initial color coincidence task is performed are explained.

The convergence control unit 160 generates an automatic convergence compensation data to compensate the convergence distortion if the convergence distortion of the present image is measured as performing the initial color coincidence task.

The convergence control unit 160 allows the automatic convergence compensation data as generated above to be stored into a predetermined region of the memory 140.

The convergence control unit 160 according to the present invention generates the manual convergence compensation data for compensating the distortions of a convergence according to the executed color coincidence task, in case that the manual color coincidence task is performed through the input unit 170 when executing the initial color coincidence task. Further, the convergence control unit 160 allows the manual convergence compensation data as generated above to be stored into a predetermined region of the memory 140.

The convergence control unit 160 according to the present invention generates a summed compensation data by summing up the automatic color coincidence task and the manual color coincidence task which are created when executing the initial color coincidence task, and compensates the influence of the earth magnetic field which the deflection circuit 130 applies on the CRT 110 by controlling the deflection control unit 190 according to the generated summed compensation data.

On the other hand, the convergence control unit 160 according to the present invention reads the initial compensation data, the automatic convergence compensation data and the manual convergence compensation data which are stored into the memory 140, respectively when executing the color coincidence task after the initial color coincidence task, and sums them up. Then, the convergence control unit 160 compensates the influence of the earth magnetic field which the deflection circuit 130 applies on the CRT 110 by controlling the deflection control unit 190 according to the summed compensation data.

Further, the convergence control unit 160 according to the present invention reads the initial compensation data, and the automatic convergence compensation data which are stored into the memory 140, respectively when executing the color coincidence task after the initial color coincidence task, and sums them up. Then, the convergence control unit 160 compensates the influence of the earth magnetic field which the deflection circuit 130 applies on the CRT 110 by controlling the deflection control unit 190 according to the summed compensation data. Under this state, the convergence control unit 160 reads the manual convergence compensation data which is stored into the memory 140, and compensates the influence of the earth magnetic field which the deflection circuit 130 applies on the CRT 110 by controlling the deflection control unit 190 according to the manual convergence compensation data. On the contrary, after a user judges that the automatic color coincidence task is necessary against the distortions of a convergence of the picture image on which the initial compensation data, and the automatic convergence compensation data are applied, if a command for the automatic color coincidence task is inputted through the input unit 170, the distortions of a convergence of the picture image are measured according to the control of the main control unit 180. Then an automatic convergence compensation data is generated for compensating the distortions of a convergence measured by the convergence control unit 160, and the convergence control unit 160 allows such an automatic convergence compensation data as generated above to be updated with respect to the automatic convergence compensation data which is already stored into the memory 140. In addition, the convergence control unit 160 performs the automatic color coincidence task once again using the automatic convergence compensation data which is updated and stored.

As described above, if the power is supplied to the projection television, the automatic color coincidence task may be executed before a selected broadcasting signal is outputted to the CRT 110, and the automatic color coincidence task may be performed in case that the command for the automatic color coincidence task is inputted by a user.

According to the present invention, the manual color coincidence task is performed through the input unit 170. According to the present invention, a command for the automatic color coincidence task may be inputted through the input unit 170.

The main control unit 180 according to the present invention controls the optical sensor (S₁, S₂, S₃, S₄) while performing the initial color coincidence task, and measures the brightness of a reference pattern. Therefore, the distortions of a convergence of the present picture image can be measured.

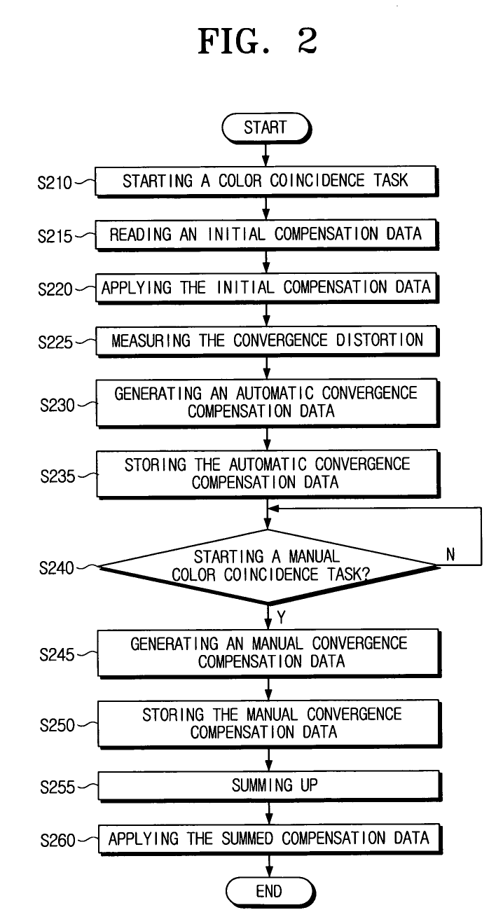

FIG. 2 is a flow chart explaining initial color coincidence execution procedures according to the present invention, where “S” denotes the step.

Referring to FIG. 1 and FIG. 2, in case that the color coincidence task is executed (S210), the initial compensation data which is stored into the memory 140 is read by the convergence control unit 160 (S215).

Then, the read initial compensation data is applied on a task for compensating the distortions of a convergence by the convergence control unit 160 (S220).

Then, the distortion of a convergence of the present picture image is measured. Such measurement of the distortions of a convergence is measured by the optical sensor (S₁, S₂, S₃, S₄) under the control of the main control unit 180 (S225).

Further, according to the measured results, an automatic convergence compensation data is generated by the convergence control unit 160, based upon the digital data outputted from the A/D converter 150 (S230). The generated automatic convergence compensation data is stored into a predetermined region of the memory 140 under the control of the convergence control unit 160 (S235).

On the other hand, in case that the manual color coincidence task is performed by a user through the input unit 170 (S240), a manual convergence compensation data is generated through a predetermined procedure by the convergence control unit 160 (S245). The generated manual convergence compensation data is stored into a predetermined region of the memory 140 under the control of the convergence control unit 160 (S250).

Further, the manual convergence compensation data, and the automatic convergence compensation data are summed up by the convergence control unit 160 (S225), and a task for compensating the distortions of a convergence is performed by the convergence control unit 160 after applying the summed compensation data (S260).

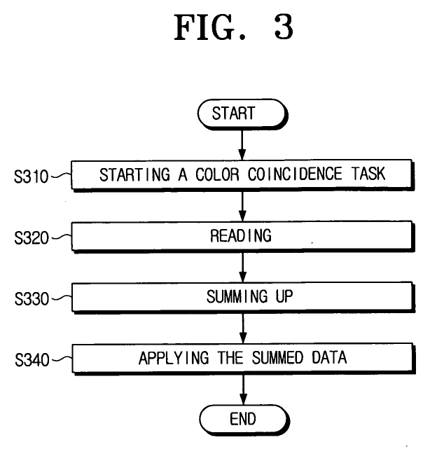

FIG. 3 is a flow chart explaining color coincidence execution procedures after the initial color coincidence execution procedures according to the present invention.

Referring to FIG. 1 and FIG. 3, in case that a task for compensating the distortions of a convergence which is same to the task for compensating the distortions of a convergence as is shown in FIG. 2, that is, the color coincidence task is executed (S310), the initial compensation data, the manual convergence compensation data, and the automatic convergence compensation data are read from the memory 140 by the convergence control unit 160 (S320).

Then, the initial compensation data, the manual convergence compensation data, and the automatic convergence compensation data which are read by the convergence control unit 160 are summed up (S330), and then, a task for compensating the distortions of a convergence is performed by the convergence control unit 160 after applying summed compensation data (S340).

In this way, in case that the color coincidence task of FIG. 3 is performed after the color coincidence task of FIG. 2, it is not necessary to perform the manual color coincidence task and the automatic color coincidence task additionally.

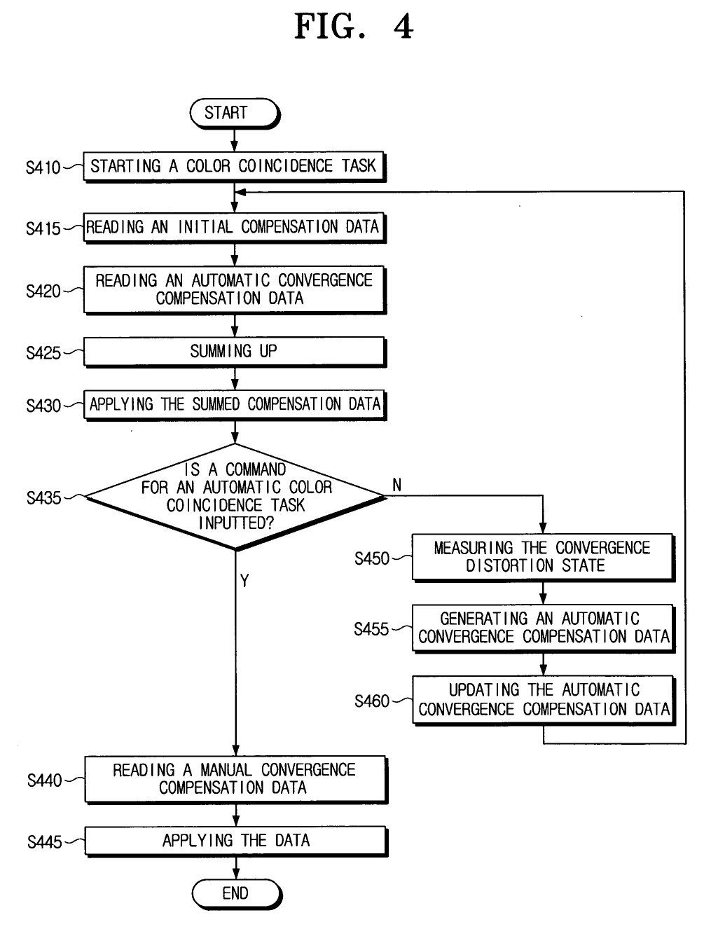

FIG. 4 is a flow chart for explaining other color coincidence execution procedures after the initial color coincidence execution procedures according to the present invention.

Referring to FIGS. 1, 2, and 4, if the convergence distortion compensation task, i.e., the color coincidence task, is executed again after the convergence distortion compensation task as FIG. 2 (S410), the initial compensation data, and the automatic convergence compensation data are read from the memory 140 by the convergence control unit 160 (S415, S420).

Then, the initial compensation data, and the automatic convergence compensation data which are read by the convergence control unit 160 are summed up (S425), and then, a task for compensating the distortions of a convergence is performed by the convergence control unit 160 after applying the summed compensation data (S430).

Further, in case that a user judges the color coincidence task is not necessary on the screen 120 which a task for compensating the distortions of a convergence of the S430 step was performed (S435), the manual convergence compensation data which is stored into the memory 140 is read by the convergence control unit 160 (S440), and the manual color coincidence task is performed by applying the manual convergence compensation data (S445). On the contrary, in case that a user judges the automatic color coincidence task is necessary for the screen 120 on which a task for compensating the distortions of a convergence of the S430 step was performed (S435), and then inputs a command for the automatic color coincidence task (S435), the distortions of a convergence of the present picture image can be measured by the optical sensor (S₁, S₂, S₃, S₄) under the control of the main control unit 180 (S450).

In addition, according to the measured results, an automatic convergence compensation data is generated by the convergence control unit 160, based upon the digital data outputted from the A/D converter 150 (S455).

The generated automatic convergence compensation data is stored into a predetermined region of the memory 140 under the control of the convergence control unit 160 (S460).

The steps S415, S420, S425, S430, and S435 are repeated under the control of the main control unit 180 (S450).

Until now, as described above, according to the convergence compensation apparatus and method of the present invention, the manual convergence compensation data is stored into a predetermined region of the memory, and then this is used in the manual color coincidence task. Therefore, there is a benefit that the manual color coincidence task which is required after the automatic color coincidence task becomes unnecessary, unlike a conventional technology, and thereby a troublesome process of a user is eliminated. Further, the automatic convergence compensation data is stored into a predetermined region of the memory, and then this is used in the automatic color coincidence. Therefore, there is a benefit that the change of a screen image can be minimized.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A convergence compensation method for compensating a convergence distortion of a projection television, comprising:
compensating a convergence distortion of said projection television by applying a manual convergence compensation data which are preset and stored by a user.

2. The method as claimed in claim 1, further comprising:
generating said manual convergence compensation data by performing a manual color coincidence task for compensating a convergence distortion of said projection television by manipulation of a user; and
storing said generated manual convergence compensation data.

3. The method as claimed in claim 1, further comprising:
compensating a convergence distortion of said projection television by applying an automatic convergence compensation data generated and stored by an automatic color coincidence task for automatically compensating a convergence distortion of said projection television.

4. The method as claimed in claim 3, further comprising:
measuring a convergence distortion state of said projection television;
generating said automatic convergence compensation data by performing the automatic color coincidence task for automatically compensating a convergence distortion of said projection television according to said measured convergence distortion state, and
storing said generated automatic convergence compensation data.

5. A convergence compensation method for compensating a convergence distortion of a projection television, comprising:
compensating a convergence distortion of said projection television by applying an automatic convergence compensation data generated and already stored by an automatic color coincidence task for automatically compensating a convergence distortion of said projection television, when performing another automatic color coincidence task which is different from said automatic color coincidence task.

6. The method as claimed in claim 5, further comprising:
measuring a distortion state of a convergence of said projection television;
generating said automatic convergence compensation data by performing the automatic color coincidence task according to said measured convergence distortion state; and
storing said generated automatic convergence compensation data.

7. The method as claimed in claim 5, further comprising:
performing an automatic color coincidence task according to an execution command for the automatic color coincidence task, when said execution command for the automatic color coincidence task is inputted, and
updating said automatic convergence compensation data with an automatic convergence compensation data generated by said automatic color coincidence task.

8. A convergence compensation apparatus performing an automatic color coincidence task for automatically compensating a convergence distortion of a projection television, the apparatus comprising:
a memory for storing a manual convergence compensation data which is preset by a user; and
a convergence control unit for applying said manual convergence compensation data and an automatic convergence compensation data generated by said automatic color coincidence task, and for allowing a convergence distortion of said projection television to be compensated.

9. The apparatus as claimed in claim 8, wherein said memory further stores said preset automatic convergence compensation data; and
said convergence control unit reads said automatic convergence compensation data stored when performing an automatic color coincidence task, and applies the data to said automatic color coincidence task.

10. A convergence compensation apparatus performing an automatic color coincidence task for automatically compensating a convergence distortion of a projection television, the apparatus comprising:
a memory for storing an automatic convergence compensation data generated by an automatic color coincidence task; and
a convergence control unit for allowing said stored automatic convergence compensation data to be applied to another automatic color coincidence task, when performing the other automatic color coincidence task which is different from said automatic color coincidence task.

11. The apparatus as claimed in claim 10, further comprising:
an input unit to which an execution command for the automatic color coincidence task is inputted,
wherein said convergence control unit updates the automatic convergence compensation data stored in the memory with an automatic convergence compensation data generated by an automatic color coincidence task according to the execution command for the automatic color coincidence task.
